(19) United States
(12) Patent Application Publication
(10) Pub. No.: US 2018/0362811 A1
(43) Pub. Date: Dec. 20, 2018

(54) ADHESIVE ARTICLES THAT INCLUDE A POLYMER FOAM AND METHODS OF MAKING THE SAME

(71) Applicant: 3M INNOVATIVE PROPERTIES COMPANY, St Paul, MN (US)

(72) Inventors: Robert D. Waid, Maplewood, MN (US); Shijing Cheng, Woodbury, MN (US); Thu-Van T. Tran, Maplewood, MN (US); David J. Yarusso, Shoreview, MN (US)

(21) Appl. No.: 16/061,582

(22) PCT Filed: Dec. 13, 2016
(86) PCT No.: PCT/US16/66249

§ 371 Date: Jun. 12, 2018

Related U.S. Application Data
(60) Provisional application No. 62/269,184, filed on Dec. 18, 2015.

(51) Int. Cl. C09J 7/38; C09J 7/26; C08K 3/04; C08K 7/24; C08J 9/228; C09J 133/08; C09J 133/10; C09J 133/24; C09J 133/18; C09J 125/06; C09J 125/16; C09J 11/04

(52) U.S. Cl. CPC C09J 7/38; C08J 2400/22; C08K 3/04; C08K 7/24; C08J 9/228; C09J 133/08; C09J 133/10; C09J 133/24; C09J 133/18; C09J 125/06; C09J 125/16; C09J 11/04; C09J 2400/24; C09J 2205/11; C09J 2205/106; C09J 2205/102; C09J 7/26

(57) ABSTRACT

Described herein is a foam adhesive article comprising: a closed cell foam layer comprising an extruded thermoplastic polymer foam and particles distributed therein, wherein the particles comprise a plurality of hollow particles, wherein the hollow particles comprise at least one of thermoplastic expanded polymeric particles, glass particles, and mixtures thereof; and a plurality of sorbent particles. Also disclosed herein are precursor compositions and methods of making such constructions.

### TECHNICAL FIELD

Adhesive articles comprising a polymeric foam are described herein, wherein the polymeric foam comprises a sorbent material to sorb volatile organic compounds from the adhesive article.

### DESCRIPTION OF THE FIGURE

FIG. 1 is a cross-sectional view of a foam adhesive article according to one embodiment of the present disclosure.

### SUMMARY

Articles incorporating a polymer foam core are known. The foam includes a polymer matrix and is characterized by a density that is lower than the density of the polymer matrix itself. Density reduction is achieved in a number of ways, including through creation of gas-filled voids in the matrix (e.g., by means of a blowing agent) or inclusion of polymeric microspheres (e.g., expandable microspheres) or non-polymeric microspheres (e.g., glass microspheres).

There is a desire to provide foam-containing adhesive articles having a material to sorb volatile organic compounds.

In one aspect, a foam adhesive article is described comprising: a closed cell foam layer comprising an extruded thermoplastic polymer foam and particles distributed therein, wherein the particles comprise: (a) a plurality of hollow particles, wherein the hollow particles comprise at least one of (i) thermoplastic expanded polymeric particles, (ii) non-polymeric particles, and (iii) mixtures thereof; and (b) a plurality of sorbent particles, wherein the sorbent particle has a high specific surface area.

In another aspect, expandable foam precursor composition is described comprising: a thermoplastic polymer matrix and particles distributed therein, wherein the particles comprise: a plurality of thermoplastic expandable polymeric particles; and a plurality of sorbent particles, wherein the sorbent particle has a high specific surface area

In yet another aspect, a method of making a foam adhesive article is described comprising: extruding a composition to form a closed cell foam layer the composition comprising (i) a thermoplastic polymer (ii) a plurality of hollow particles, wherein the hollow particles comprise at least one of thermoplastic expandable polymeric particles, non-polymeric particles, and mixtures thereof; and (iii) plurality of sorbent particles, wherein the sorbent particle has a high specific surface area.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term

“a”, “an”, and “the” are used interchangeably and mean one or more;

“and/or” is used to indicate one or both stated cases may occur, for example A and/or B includes, (A and B) and (A or B); and

“expandable polymeric particle” is a particle that includes a polymer shell and a core material in the form of a gas, liquid, or combination thereof, that expands upon heating. Expansion of the core material, in turn, causes the shell to expand, at least at the heating temperature. An expandable polymeric particle is one where the shell can be initially expanded or further expanded without breaking. Some particles may have polymer shells that only allow the core material to expand at or near the heating temperature; and

“polymer” used according to the present invention can preferably possess a weight average molecular weight of at least about 10,000 g/mol, and more preferably at least about 50,000 g/mol or even 100,000 g/mol.

Also herein, recitation of ranges by endpoints includes all numbers subsumed within that range (e.g., 1 to 10 includes 1.4, 1.9, 2.33, 5.75, 9.98, etc.).

Also herein, recitation of“at least one” includes all numbers of one and greater (e.g., at least 2, at least 4, at least 6, at least 8, at least 10, at least 25, at least 50, at least 100, etc.).

Volatile organic compounds (VOCs) are any compounds comprising carbon (excluding carbon monoxide, carbon dioxide, carbonic acid, metallic carbides or metallic carbonates, and ammonium carbonate) that have sufficient vapor pressures such that under normal conditions, vaporize, and enter the atmosphere. It can be advantageous to contain VOCs in finished goods, such as adhesive articles, to (a) limit VOC release into the environment, which can be environmentally or odorously undesirable, and/or (b) prevent the VOC from impacting the performance or aesthetics of the finished good.

VOCs as disclosed herein include permeable substances which migrate through the adhesive article and either (a) impact the performance or aesthetics of the adhesive article and/or (b) outgas from the adhesive article causing odor, fogging, and/or environmental concerns. The permeable substances can include volatile and semi-volatile organic compounds. Typically volatile compounds would comprise those compounds having up to 20 carbon atoms, whereas the semi-volatile compounds would comprise those compounds having 16 to 32 carbon atoms. The VOCs of interest to capture in the present disclosure are solvents and raw materials used in manufacture, contaminants in the raw materials, and/or by-products from the manufacture. Exemplary VOCs include, acetonitrile, 1-butanol, chlorobenzene, chloroform(trichloromethane), cyclohexane, diethyl ether, 1,4-dioxane, glacial acetic acid(acetic acid), acetic anhydride, acetic acid ethyl ester(ethyl acetate, ethyl ethanoate), acetic acid n-butyl ester(n-butyl acetate), acetic acid tert-butyl ester(tert-butyl acetate), ethanol, methanol, n-hexane, n-heptane, 3-hexanone, 2-propanol(isopropanol), 3-methyl-1-butanol(isoamyl alcohol), methylene chloride(dichloromethane), 2-ethyl hexyl acrylate, 2-ethyl hexyl alcohol, 2-ethyl hexyl acetate, methyl ethyl ketone(butanone), methyl isobutyl ketone, nitromethane(nitrocarbol), n-pentane, 2-pentanone, 3-pentanone, petroleum ether(light benzine), benzine, propanol, pyridine(azine), tert-butyl methyl ether, tetrachloroethene(perchloroethene), tetrahydrofuran, toluene, trichloroethane, triethylamine, xylene, methane, ethane, propane, propene, butane, and butene.

The present application is directed toward a foam adhesive article. The foam layer of the present disclosure comprises a sorbent material entrapped in closed cell polymer matrix. The foam adhesive article is an article having a surface available for bonding that is tacky at room temperature (i.e., pressure sensitive adhesive articles). An example of a foam adhesive article is a foam that itself is an adhesive, or an article that includes one or more separate adhesive compositions bonded to the foam, e.g., in the form of a continuous layer or discrete structures (e.g., stripes, rods, filament, etc.), in which case the foam itself need not be an adhesive.

Sorbent Particles

The foam of the present disclosure comprises a sorbent particle capable of sorbing the VOCs. The sorbing of the VOCs by the sorbing particle occurs via absorption and/or adsorption. Adsorption may occur in the form of chemisorption and/or physisorption.

In one embodiment, the sorbent particle is porous. The porous nature will enable, for example, more surface area for VOC removal. Preferably, the sorbent particle has a high specific surface area (e.g., at least 100, 200, 500, 600 or even 700 m²/g; and at most 1000, 1200, 1400, 1500, or even 1800 m²/g based on BET (Brunauer Emmet Teller method) nitrogen adsorption).

The sorbent particle may be microporous (having pore widths smaller than 2 nanometers), macroporous (having pore widths between 2 and 50 nanometers), mesoporous (having pore widths larger than 50 nm), or a mixture thereof.

In one embodiment, the sorbent particle is predominately microporous, meaning that 65, 75, 80, 85, 90, 95, or even 99% of the pores are microporous, however some of the pores may be larger than microporous.

Exemplary sorbent particle include activated carbon, silica gel, and zeolites.

Activated carbon, is carbon that has been processed to make it highly porous (i.e., having a large number of pores per unit volume), which thus, imparts a high surface area. Activated carbons may be generated from a variety of materials, however most commercially available activated carbons are made from peat, coal, lignite, wood, and coconut shells. Based on the source, the carbon can have different pore sizes, ash content, surface order, and/or impurity profiles. Coconut shell-based carbon has predominantly a microporus pore size, whereas a wood-based activated carbon has a predominately mesoporous or macroporous pore size. Coconut shell- and wood-based carbon typically have ash contents less than about 3% by weight, whereas coal-based carbons typically have ash contents of 4-10% by weight or even higher.

Commercially available activated carbons include: activated wood-based carbon available under the trade designation “NUCHAR RGC”, by Mead Westvaco Corp, Richmond, Va.; wood-based carbon available under the trade designation “AQUAGUARD” by Mead Westvaco Corp; activated coconut shell-based carbon available under the trade designation “KURARAY PGW” by Kuraray Chemical Co., LTD, Okayama, Japan; and coal-based carbon available under the trade designations “CARBSORB” and “FILTRASORB” by Calgon Carbon Corp., Pittsburgh, Pa.

Silica gel is a vitreous, porous form of silicon dioxide that is hydroscopic and commonly used as a desiccant. Typically silica gel is made from the acidification of sodium silicate solutions, which is then washed and dehydrated to form a microporous silica.

Zeolites are porous aluminosilicate minerals, which are highly crystalline. Zeolites can occur naturally or be produced synthetically. A commercially available zeolite includes ZEOFLAIR a microporous, organophilic inorganic powder available from Zeochem AG, Karst, Germany.

In one embodiment, the sorbent particle is distributed throughout the foam layer. In one embodiment, the sorbent particle is distributed substantially uniformly through a cross-section of the foam layer, meaning that the sorbent particle is present at roughly the same concentration (e.g., within 10%) throughout the cross-section of the foam layer.

In one embodiment, the sorbent material is present in at least 1, 3, 5% or even 10% by weight per weight of the foam layer; and no more than 25%, 20%, or even 15% or less by weight per weight of the foam layer.

Closed Cell Foam

The foam of the present disclosure is a closed cell foam, meaning that the foam comprises discrete open pockets of gas within the solid polymer matrix. Generally, the open pockets of gas are not connected to one another. In the present disclosure, these open pockets are generated from the use of thermoplastic expandable polymeric particles or hollow, non-polymeric, inorganic particles, such as glass particles. These particles generate the discrete open pockets of gas within the polymer matrix of the foam.

Examination of the foam layer by electron microscopy reveals that the foam microstructure is characterized by a plurality of enlarged particles (relative to their original size) distributed throughout the polymer matrix. In one embodiment, at least a fraction of the thermoplastic polymeric particles may still be expandable, i.e., upon application of heat it will expand further without breaking. This can be demonstrated by exposing the foam to a heat treatment and comparing the size of the particles obtain by electron microscopy to their pre-heat treated size (also obtained by electron microscopy).

A variety of different polymer resins, as well as blends thereof, may be used for the polymer matrix of the foam as long as the resins are suitable for melt extrusion processing. For example, it may be desirable to blend two or more acrylate polymers having different compositions. A wide range of foam physical properties can be obtained by manipulation of the blend component type and concentration of the polymer matrix. The particular resin is selected based upon the desired properties of the final foam-containing article. The morphology of the immiscible polymer blend that comprises the foam matrix can enhance the performance of the resulting foam article. The blend morphology can be, for example, spherical, ellipsoidal, fibrillar, co-continuous or combinations thereof. These morphologies can lead to a unique set of properties that are not obtainable by a single component foam system. Such unique properties may include, for example, anisotropic mechanical properties, enhanced cohesive strength. The morphology (shape & size) of the immiscible polymer blend can be controlled by the free energy considerations of the polymer system, relative viscosities of the components, and most notably the processing and coating characteristics. By proper control of these variables, the morphology of the foam can be manipulated to provide superior properties for the intended article.

One class of useful polymers includes acrylate and methacrylate adhesive polymers and copolymers. Such polymers can be formed by polymerizing one or more monomeric acrylic or methacrylic esters of non-tertiary alkyl alcohols, with the alkyl groups having from 1 to 20 carbon atoms (e.g., from 3 to 18 carbon atoms). Suitable acrylate monomers include methyl acrylate, ethyl acrylate, n-butyl acrylate, lauryl acrylate, 2-ethylhexyl acrylate, cyclohexyl acrylate, iso-octyl acrylate, octadecyl acrylate, nonyl acrylate, decyl acrylate, and dodecyl acrylate. The corresponding methacrylates are useful as well. Also useful are aromatic acrylates and methacrylates, e.g., benzyl acrylate and cyclobenzyl acrylate.

Optionally, one or more monoethylenically unsaturated co-monomers may be polymerized with the acrylate or methacrylate monomers; the particular amount of co-monomer is selected based upon the desired properties of the polymer. One group of useful co-monomers includes those having a homopolymer glass transition temperature greater than the glass transition temperature of the acrylate homopolymer. Examples of suitable co-monomers falling within this group include acrylic acid, acrylamide, methacrylamide, substituted acrylamides such as N,N-dimethyl acrylamide, itaconic acid, methacrylic acid, acrylonitrile, methacrylonitrile, vinyl acetate, N-vinyl pyrrolidone, isobornyl acrylate, cyano ethyl acrylate, N-vinylcaprolactam, maleic anhydride, hydroxyalkylacrylates, N,N-dimethyl aminoethyl (meth)acrylate, N,N-diethylacrylamide, beta-carboxyethyl acrylate, vinyl esters of neodecanoic, neononanoic, neopentanoic, 2-ethylhexanoic, or propionic acids, vinylidene chloride, styrene, vinyl toluene, and alkyl vinyl ethers.

A second group of monoethylenically unsaturated co-monomers which may be polymerized with the acrylate or methacrylate monomers includes those having a homopolymer glass transition temperature less than the glass transition temperature of the acrylate homopolymer. Examples of suitable co-monomers falling within this class include ethyloxyethoxy ethyl acrylate (Tg=−71° C.) and a methoxypolyethylene glycol 400 acrylate (Tg=−65° C.; available from Shin Nakamura Chemical Co., Ltd. under the trade designation “NK ESTER AM-90G”).

A second class of polymers useful for the polymer matrix of the foam includes acrylate-insoluble polymers. Examples include semicrystalline polymer resins such as polyolefins and polyolefin copolymers (e.g., based upon monomers having between 2 and 8 carbon atoms such as low density polyethylene, high density polyethylene, polypropylene, ethylene-propylene copolymers, etc.), polyesters and co-polyesters, polyamides and co-polyamides, fluorinated homopolymers and copolymers, polyalkylene oxides (e.g., polyethylene oxide and polypropylene oxide), polyvinyl alcohol, ionomers (e.g., ethylene-methacrylic acid copolymers neutralized with base), and cellulose acetate. Other examples of acrylate-insoluble polymers include amorphous polymers having a solubility parameter (as measured according to the Fedors' technique) less than 8 or greater than 11 such as polyacrylonitrile, polyvinyl chloride, aromatic epoxies, polycarbonate, amorphous polyesters, amorphous polyamides, ABS (acrylonitrile butadiene styrene) copolymers, polyphenylene oxide alloys, ionomers (e.g., ethylene-methacrylic acid copolymers neutralized with salt), fluorinated elastomers, and polydimethyl siloxane.

A third class of polymers useful for the polymer matrix of the foam includes elastomers containing ultraviolet radiation-activatable groups. Examples include polybutadiene, polyisoprene, polychloroprene, random and block copolymers of styrene and dienes (e.g., styrene-butadiene rubber), and ethylene-propylene-diene monomer rubber.

A fourth class of polymers useful for the polymer matrix of the foam includes pressure sensitive and hot melt adhesives prepared from non-photopolymerizable monomers. Such polymers can be adhesive polymers (i.e., polymers that are inherently adhesive), or polymers that are not inherently adhesive, but are capable of forming adhesive compositions when compounded with tackifiers. Specific examples include poly-alpha-olefins (e.g., polyoctene, polyhexene, and atactic polypropylene), block copolymer-based adhesives (e.g., di-block, tri-block, star-block and combinations thereof), natural and synthetic rubbers, silicone adhesives, ethylene-vinyl acetate, and epoxy-containing structural adhesive blends (e.g., epoxy-acrylate and epoxy-polyester blends).

The closed cell network of the foam is achieved by the presence of hollow particles within the foam layer. These hollow particles may be polymeric or non-polymeric in nature.

The polymeric hollow particles are made from expandable particles which are added during the compounding and extrusion of the foam layer. The expandable polymeric particles feature a flexible, thermoplastic, polymeric shell and a core that includes a liquid and/or gas, which expands upon heating. Preferably, the core material is an organic substance that has a lower normal boiling point than the softening temperature of the polymeric shell. Examples of suitable core materials include propane, butane, pentane, isobutane, neopentane, and combinations thereof.

The choice of thermoplastic resin for the polymeric shell influences the mechanical properties of the foam. Accordingly, the properties of the foam may be adjusted through appropriate choice of hollow particles, or by using mixtures of different types of particles. For example, acrylonitrile-containing resins are useful where high tensile and cohesive strength are desired, particularly where the acrylonitrile content is at least 50% by weight of the resin, more preferably at least 60% by weight, and even more preferably at least 70% by weight. In general, both tensile and cohesive strength increase with increasing acrylonitrile content. In some cases, it is possible to prepare foams having higher tensile and cohesive strength than the polymer matrix alone, even though the foam has a lower density than the matrix. This provides the capability of preparing high strength, low density articles.

Examples of suitable thermoplastic resins which may be used as the shell include acrylic and methacrylic acid esters such as polyacrylate; acrylate-acrylonitrile copolymer; and methacrylate-acrylic acid copolymer. Vinylidene chloride-containing polymers such as vinylidene chloride-methacrylate copolymer, vinylidene chloride-acrylonitrile copolymer, acrylonitrile-vinylidene chloride-methacrylonitrile-methyl acrylate copolymer, and acrylonitrile-vinylidene chloride-methacrylonitrile-methyl methacrylate copolymer may also be used, but are not preferred where high strength is desired. In general, where high strength is desired, the particle shell preferably has no more than 20% by weight vinylidene chloride, more preferably no more than 15% by weight vinylidene chloride. Even more preferred for high strength applications are particles having essentially no vinylidene chloride units.

Examples of suitable commercially available expandable polymeric particles include those available from Matsumoto Yushi-Seiyaku Co. Ltd., Osaka, Japan under the designations “F-65”, “FN-100S”, and “FN-100”. Also suitable are expandable polymeric particles available from Akzo-Nobel under the designations “EXPANCEL 551” “EXPANCEL 461” and “EXPANCEL 091”. Each of these particles features an acrylonitrile-containing shell. In addition, the F-65, FN-100S, FN-100D, and EXPANCEL 091 particles have essentially no vinylidene chloride units in the shell.

In one embodiment, the core of the expandable polymeric particle includes a material other than air that expands upon heating.

In one embodiment, the unexpanded polymeric particles has a diameter of at least 1, 2, 5 or even 10 micrometers and at most 20, 25, or even 40 micrometers.

Non-polymeric hollow particles include inorganic-based hollow particles, such as glass and ceramic-containing particles. To survive the compounding and/or extrusion processes, in many embodiments, the plurality of hollow non-polymeric particles have a crush strength (target survival of about 90%) of less than 10,000 pounds per square inch (psi) (68.9 megaPascals (MPa)), or less than 5,000 psi (34.5 MPa), or less than 2,000 psi (13.8 MPa).

Crush strength is measured by a Nitrogen Isostatic Crush Strength test method. This method determines the % volume reduction of a hollow element sample when subjected to a specified Nitrogen pressure knowing the density of the hollow elements. A mixture of hollow element and talc is placed into a pycnometer cup and the density of the mixture is determined. Then the mixture is placed into an autoclave pressure testing apparatus and subjected to a nitrogen pressure cycle of a known pressure. After the pressure cycle, the density of the mixture is measured and compared to the initial density. The percent survival is then determined by the following formula: % survival=100−[[(P_{F}−P_{I})(B+T)×100]/[P_{F}[B+T−(P_{I}/P_{T})T]]] where P_{I} is the initial sample density, P_{F} if the final sample density, P_{T} is the talc density, B is the weight of the hollow elements and T is the weight of the talc.

Useful hollow glass particles include those marketed by 3M Co. (St. Paul, Minn.) under the trade designation “3M GLASS BUBBLES” (e.g., grades—S32, K37, S38, S38HS, S38XHS, K46, D32/4500, H50/10000, S60, S60HS, and iM30K); glass bubbles marketed by Potters Industries, Valley Forge, Pa., (an affiliate of PQ Corporation) under the trade designations “Q-CEL HOLLOW SPHERES” and “SPHERICEL HOLLOW GLASS SPHERES” and hollow glass particles marketed by Silbrico Corp., Hodgkins, Ill. under the trade designation “SIL-CELL”.

Exemplary hollow ceramic particles include: aluminosilicate particles extracted from pulverized fuel ash collected from coal-fired power stations (i.e., cenospheres). Useful cenospheres include those marketed by Sphere One, Inc., Chattanooga, Tenn., under the trade designation “EXTENDOSPHERES HOLLOW SPHERES” (e.g., grades SG, MG, CG, TG, HA, SLG, SL-150, 300/600, 350 and FM-1); and those marketed by 3M Company under the trade designation “3M HOLLOW CERAMIC MICROSPHERES” (e.g., grades G-3125, G-3150, and G-3500).

In some embodiments, the hollow non-polymeric particles have an average true density in a range from 0.1 g/cm³ to 1.2 g/cm³, from 0.1 g/cm³ to 1.0 g/cm³, from 0.1 g/cm³ to 0.8 g/cm³, from 0.1 g/cm³ to 0.5 g/cm³, or, in some embodiments, 0.3 g/cm³ to 0.5 g/cm³. For some applications, the hollow non-polymeric particles utilized in articles according to the present disclosure may be selected based on their density to lower the thermal conductivity of the article as much as possible, which is useful, for example, for thermal insulation. Accordingly, in some embodiments, the hollow non-polymeric particles have an average true density of up to or less than 0.5 grams per cubic centimeter. The term “average true density” is the quotient obtained by dividing the mass of a sample of hollow particles by the true volume of that mass of hollow particles as measured by a gas pycnometer. The “true volume” is the aggregate total volume of the hollow particles, not the bulk volume. For the purposes of this disclosure, average true density is measured using a pycnometer according to ASTM D2840-69, “Average True Particle Density of Hollow Microspheres”. The pycnometer may be obtained, for example, under the trade designation “ACCUPYC 1330 PYCNOMETER” from Micromeritics, Norcross, Ga. Average true density can typically be measured with an accuracy of 0.001 g/cc. Accordingly, each of the density values provided above can be ±one percent.

In one embodiment, the non-polymeric particles of the present disclosure have a diameter of at least 5, 10, or even 20 micrometers and at most 40, 60, or even 80 micrometers.

The hollow particles of the present disclosure can have any useful shape. In many embodiments, the hollow elements are oblong, or elliptical, and more preferably spherical. In some embodiments, the hollow elements have a spherical shape and are described as hollow bubbles.

The amount of hollow particle used is selected based upon the desired properties of the foam product. In general, the higher the hollow particle concentration, the lower the density of the foam. In general, the amount of hollow particles ranges from about 0.1 parts by weight to about 50 parts by weight (based upon 100 parts of polymer resin), more preferably from about 0.5 parts by weight to about 20 parts by weight.

The foam may also include a number of other additives in addition to hollow particles, the choice of which is dictated by the properties needed for the intended application of the article. Examples of suitable additives include tackifiers (e.g., rosin esters, terpenes, phenols, and aliphatic, aromatic, or mixtures of aliphatic and aromatic synthetic hydrocarbon resins), plasticizers, pigments, dyes, reinforcing agents, hydrophobic or hydrophilic silica, calcium carbonate, toughening agents, fire retardants, antioxidants, finely ground polymeric particles such as polyester, nylon, or polypropylene, stabilizers, and combinations thereof. Chemical blowing agents may be added as well. The agents are added in amounts sufficient to obtain the desired end properties.

In the present disclosure, the foam layer is substantially smooth, meaning that the surface has a substantial absence of visually observable macroscopic defects such as wrinkles, corrugations and creases. The smooth surface can enable adequate contact and, thereby, adhesion to the substrate of interest (e.g., an adhesive layer).

Articles

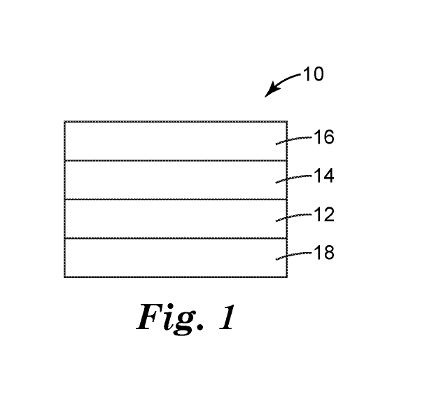

FIG. 1 depicts one exemplary embodiment of an adhesive article according to the present disclosure. Adhesive article 10 comprises foam layer 12 and adhesive layer 14, which is fixedly attached to foam layer 12. The adhesive article may optionally comprise liner 16 in contact with adhesive layer 14, opposite foam layer 12. Optional layer 18 can be a backing applied onto the backside of the foam layer, opposite the adhesive layer. Optional layer 18 could also be a second adhesive layer to form a double-sided foam tape.

The foam layer comprises a first and second major surface, wherein the first major surface contacts a first adhesive layer. The adhesive layer can be laminated or bonded to the foam. In some embodiments, a primer, as is known in the art, is used between the foam and the adhesive layer to improve adhesion between the materials.

In one embodiment, the adhesive article is a double-sided foam tape, comprising a foam layer disposed between two adhesive layers, wherein the adhesive layers may be the same or different.

In the present disclosure, the adhesive layer is a pressure-sensitive adhesive (PSA) PSAs are adhesives whose set film in the dry state at room temperature remains permanently tacky and adhesive. Even with relatively weak applied pressure, PSAs permit a durable bond to be made to the substrate, and after use can be detached from the substrate again with substantially no residue. The bondability of the adhesives is based on their adhesive properties and their redetachability on their cohesive properties.

The PSAs used in the present disclosure include those known in the art. The pressure-sensitive adhesive can include a solvent-based pressure-sensitive adhesive and/or a water-based pressure-sensitive adhesive, a hot melt coated pressure sensitive adhesive or an adhesive formed by polymerization on a substrate. The pressure-sensitive adhesive can include at least one of an acrylic, a tackified acrylic, a vinyl ether, a tackified rubber-based adhesive (wherein the rubber is for example: natural rubber, styrene-isoprene copolymers, an acrylonitrile-butadiene copolymer, styrene-butadiene copolymer, acrylic polymer), silicone, polyurethanes, polyesters, and vinyl ethers.

In some embodiments tackifiers and plasticizers may also be added to the adhesive composition that makes up the adhesive layer. Tackifiers, include for example, rosin, rosin derivatives, hydrogenated rosin derivatives, polyterpene resins, phenolic resins, coumarone-indene resins, poly-t-butyl styrene and combinations thereof. Plasticizers include for example, hydrocarbon oils, hydrocarbon resins, polyterpenes, rosin esters, phthalates, phosphate esters, dibasic acid esters, fatty acid esters, polyethers, and combinations thereof.

In one embodiment, the adhesive compositions may be coated onto the foam layer by any of a variety of conventional coating techniques known in the art, such as roll coating, spray coating, knife coating, extrusion, die-coating, and the like.

In one embodiment, the adhesive layer thickness typically may be in the range of about 0.0025 mm to 0.13 mm (0.1 mil to 5.0 mil), and more typically in the range of about 0.0013 mm to 0.076 mm (0.5 mil to 3.0 mil).

Method of Making

Because residual solvents can increase the VOC content, in one embodiment it is desirable to manufacture the adhesive article disclosed herein in the absence of solvents. Extrusion processing is a suitable example of a process that can be done in the absence of solvents.

One exemplary method for making the foam adhesive constructions is now described. A polymer resin is initially fed into a first extruder (such as a single screw extruder) which thermally softens and renders the polymer resin melt-processable. The melt processable polymer resin will eventually form the major portion of polymer matrix of the foam. The polymer resin may be added to the first extruder in any convenient form, including pellets, billets, packages, strands, and ropes.

Next, the melt-processable resin is fed to a second extruder (e.g., a twin screw extruder) at a point immediately prior to the kneading section of the extruder. Other additives (tackifiers, plasticizers, other polymers) may be added at open ports in the twin screw extruder in solid or liquid form and thoroughly combined with the melt-processable resin through the passage through kneading zones. The mixing conditions (e.g., screw speed, screw length, screw design, and temperature) are selected to achieve optimum mixing.

The sorbent particles are also added in this step of the process, at a port or ports in the extruder which allows for thorough mixing with the melt-processable components and an appropriate residence time in the melt for efficient sorption of volatiles. Partial devolatilization of the melt is also achieved by venting through open ports of the extruder and optionally by application of vacuum to selected ports. Zones of the extruder may be isolated through melt-seals induced by reversing elements in the screw to allow effective use of vacuum in the zones between the melt seals.

Preferably, mixing is carried out at a temperature insufficient to cause the expandable polymeric particles to expand, if present. It is also possible to use temperatures in excess of the expandable polymeric particle's expansion temperature, in which case the temperature is decreased following mixing and prior to adding the hollow particles.

Where no mixing is needed, e.g., where there are no additives besides the sorbent particles, kneading steps may be omitted except as needed for the sorbent particles and hollow particles. Where the polymer resin is already in a form suitable for extrusion, the first extrusion step may be omitted and the resin added directly to the second extruder.

Once the melt-processable resin, additives, and sorbents have been adequately mixed, hollow particles are added to the resulting mixture and melt-mixed to form an extrudable composition. The purpose of the melt-mixing step is to prepare an extrudable composition in which the sorbent particles, hollow particles, and other additives, to the extent present, are distributed substantially homogeneously throughout the molten polymer resin. Typically, the melt-mixing operation uses one kneading block to obtain adequate mixing, although simple conveying elements may be used as well. The temperature, pressure, shear rate, and mixing time employed during melt-mixing are selected to prepare this extrudable composition to minimize the volatiles content and without causing the hollow particles to expand or break; once broken, the hollow particles are unable to create a foam. Specific temperatures, pressures, shear rates, and mixing times are selected based upon the particular composition being processed.

Following melt-mixing, the extrudable composition is metered into an extrusion die (e.g., a contact or drop die) through a length of transfer tubing using a gear pump that acts as a valve to control die pressure and thereby prevent premature expansion of the expandable polymeric particles. The temperature within the die is preferably maintained at substantially the same temperature as the temperature within the transfer tubing, and selected such that it is at or above the temperature required to cause expansion of the expandable polymeric particles, if present. However, even though the temperature within the tubing is sufficiently high to cause the expandable polymeric particles to expand, the relatively high pressure within the transfer tubing prevents them from expanding. Once the composition enters the die, however, the pressure drops. The pressure drop, coupled with heat transfer from the die, causes the expandable polymeric particles to expand and the composition to foam within the die. The pressure within the die continues to drop further as the composition approaches the exit, further contributing to the expandable polymeric particles' expansion within the die. The flow rate of polymer through the extruder and the die exit opening are maintained such that as the polymer composition is processed through the die, the pressure in the die cavity remains sufficiently low to allow expansion of the expandable polymeric particles before the polymer composition reaches the exit opening of the die and/or prevent crushing of the non-polymeric hollow particles.

In the case of non-polymeric hollow particles, control of pressure to facilitate expansion is not applicable, and the gear pump may be omitted from the extrusion apparatus to minimize crushing.

The shape of the foam is dictated by the shape of the exit opening of the die. Although a variety of shapes may be produced, the foam is typically produced in the form of a continuous or discontinuous sheet. The extrusion die may be a drop die, contact die, profile die, annular die, or a casting die, as known in the art.

It can be preferable for most, if not all, of the polymeric hollow particles to be partially or mostly expanded before the polymer composition exits the die.

The resultant foam may optionally be combined with a liner, which is a temporary support used to protect and/or support the foam. Suitable liner materials include silicone release liners, polyester films (e.g., polyethylene terephthalate films), and polyolefin films (e.g., polyethylene films). The liner and the foam adhesive (e.g., foam layer and at least one adhesive layer) can be laminated together between a pair of nip rollers. Following lamination or after being extruded, but before lamination, the foam is optionally exposed to radiation from an electron beam source to crosslink the foam; other sources of radiation (e.g., ion beam, thermal and ultraviolet radiation) may be used as well. Crosslinking improves the cohesive strength of the foam.

A similar process for making a closed cell foam layer is disclosed in U.S. Pat. No. 7,879,441 (Gehlsen et al.) herein incorporated by reference.

The extrusion process may be used to prepare “foam-in-place” articles, which refers to the ability of the article to be expanded or further expanded after the article has been placed at a desired location. Such articles are sized and placed in a recessed area or on an open surface, and then exposed to heat energy (e.g., infrared, ultrasound, microwave, resistive, induction, convection, etc.) to activate, or further activate, the expandable polymeric particles or blowing agent. Such recessed areas can include a space between two or more surfaces (e.g., parallel or non-parallel surfaces) such as found, for example, between two or more opposing and spaced apart substrates, a through hole or a cavity. Such open surfaces can include a flat or uneven surface on which it is desirable for the article to expand after being applied to the surface. Upon activation, the foam expands due to the expansion of the polymeric particles and/or blowing agent, thereby partially or completely filling the recess or space, or thereby increasing the volume (e.g. height) of the article above the open surface. Such articles find application, for example, as gaskets or other gap-sealing articles, vibration damping articles, tape backings, etc.

Foam-in-place articles can also be prepared by incorporating a chemical blowing agent such as 4,4′-oxybis(benzenesulfonylhydrazide) in the expandable extrudable composition. The blowing agent can be activated subsequent to extrusion to cause further expansion of the expandable polymeric particles, thereby allowing the article to fill the area in which it is placed.

The extrusion process can also be used to prepare patterned foams having areas of different densities. For example, downstream of the point at which the article exits the die, the article can be selectively heated, e.g., using a patterned roll or infrared mask, to cause expansion of the expandable polymeric particles in designated areas of the article.

The foam may also be combined with one or more additional polymer compositions, e.g., in the form of layers, stripes, rods, etc., preferably by co-extruding additional extrudable polymer compositions with the hollow particle-containing extrudable compositions.

It is also possible to conduct the co-extrusion process such that a two-layer article is produced, or such that articles having more than three layers (e.g., 10-100 layers or more) are produced. Tie layers, primers layers or barrier layers also can be included to enhance the interlayer adhesion or reduce diffusion through the construction. In addition, the interlayer adhesion of a construction having multiple layers (e.g., A/B) of different compositions can be improved by blending a fraction of the A material into the B layer (A/AB). Depending on the degree of interlayer adhesion will dictate the concentration of A in the B layer. Multilayer foam articles can also be prepared by laminating additional polymer layers to the foam layer, or to any of the co-extruded polymer layers. Other techniques which can be used include coating the extruded foam (i.e., extrudate) with stripes or other discrete structures.

Post processing techniques, which may include lamination, embossing, extrusion coating, solvent coating, or orientation, may be performed on the foam to impart superior properties. The foams may be uni-axially or multi-axially oriented (i.e., stretched in one or more directions) to produce foam structures.

The method may also include crosslinking the foam and/or the adhesive layer. Crosslinking can improve the cohesive strength of the resulting foam. For example, the foam may be exposed to thermal, actinic, or ionizing radiation or combinations thereof subsequent to extrusion to crosslink the foam, for example electron beam radiation. Crosslinking may also be accomplished by using chemical crosslinking methods based on ionic interactions. It may be desirable for the crosslinking of the extrudable polymer to at least start between the melt mixing step and exiting of the polymer through the die opening, before, during or after foaming, such as by the use of thermal energy (i.e., heat activated curing). Alternatively or additionally, the extrudable polymer composition can be crosslinked upon exiting the die such as, for example, by exposure to thermal, actinic, or ionizing radiation or combinations thereof. Crosslinking may also be accomplished by using chemical crosslinking methods based on ionic interactions. The degree of crosslinking can be controlled in order to influence the properties of the finished foam article. If the extruded polymer is laminated, as described herein, the polymer extrudate can be crosslinked before or after lamination. Suitable thermal crosslinking agents for the foam can include epoxies and amines. Preferably, the concentrations are sufficiently low to avoid excessive crosslinking or gel formation before the composition exits the die.

In one embodiment, it can be desirable for the foam to comprise a substantially uncrosslinked or thermoplastic polymeric matrix material. It can also be desirable for the matrix polymer of the foam to exhibit some degree of crosslinking. Any crosslinking should not significantly inhibit or prevent the foam from expanding to the degree desired.

It has been discovered that a foam adhesive article comprising a sorbent material in the closed cell foam layer can be used to effectively sorb VOC. The German Automotive Industry Association (Verband der Automobilindustrie (VDA)) test method VDA 278 (2011): “Thermal Desorption Analysis of Organic Emissions for the Characterization of Non-Metallic Materials for Automobiles” is a non-specific method for determining VOC amounts. In other words, this method quantitates the amount of VOCs present and does not identify the particular VOCs, other than being small carbon containing (reported as VOC) or slightly higher carbon containing (reported as FOG). In one embodiment, the adhesive article of the present disclosure has a VOC of less than 1000, 500, or even 100 as measured by the VOC Test Method I, disclosed herein, which is generally described in VDA 278 (2011). In one embodiment, the adhesive article of the present disclosure has an adhesive article has a FOG of less than 100, 50, 10, or even 5 μg/g as measured by the VOC Test Method I, disclosed herein, which is generally described in VDA 278 (2011). Other methods, such as JASO M902:2011: Diffused Volatile Organic Compounds (VOC) quantitate total VOC levels as well as identify and quantitate specific VOC compounds.

The adhesive article of the present disclosure may be provided in a variety of forms, including a sheet, rod, or cylinder.

The foam-containing adhesive articles described herein are useful in a variety of applications including, for example and not by way of limitation, aerospace, automotive, and medical applications. The properties of the articles can be tailored to meet the demands of the desired applications.

Exemplary embodiments of the present disclosure, include but are not limited to the following:

### Embodiment 1

A foam adhesive article comprising:
a closed cell foam layer comprising an extruded thermoplastic polymer foam and particles distributed therein, wherein the particles comprise:
   (a) a plurality of hollow particles, wherein the hollow particles comprise at least one of (i) thermoplastic expanded polymeric particles, (ii) non-polymeric particles, and (iii) mixtures thereof; and
   (b) a plurality of sorbent particles, wherein the sorbent particle has a high specific surface area.

### Embodiment 2

The foam adhesive article of embodiment 1, wherein the sorbent particle comprises at least one of an activated carbon, silica gel, a zeolite, and mixtures thereof.

### Embodiment 3

The foam adhesive article of any one of the previous embodiments, wherein the plurality of non-polymeric particles have a crush strength of at least 2000 psi.

### Embodiment 4

The foam adhesive article of any one of the previous embodiments, wherein the plurality of thermoplastic expanded polymeric particles comprise a thermoplastic polymeric shell and a core, wherein the core comprises at least one of a liquid, a gas, and combinations thereof.

### Embodiment 5

The foam adhesive article of any one of the previous embodiments, wherein the extruded thermoplastic polymer foam comprises an acrylic polymer formed by polymerization of (a) one or more monomeric (meth) acrylic esters of non-tertiary alkyl alcohols, wherein the alkyl alcohols have 1-20 carbon atoms and (b) one or more monomers selected from acrylic acid; acrylamide; methacrylamide; N,N-dimethyl acrylamide; itaconic acid; methacrylic acid; acrylonitrile; methacrylonitrile; vinyl acetate; N-vinyl pyrrolidone; isobornyl acrylate; cyano ethyl acrylate; N-vinylcaprolactam, maleic anhydride; hydroxyalkylacrylates; N,N-dimethyl aminoethyl (meth)acrylate; N,N-diethylacrylamide; beta-carboxyethyl acrylate; vinyl esters of neodecanoic, neononanoic, neopentanoic, 2-ethylhexanoic, or propionic acids; vinylidene chloride; styrene; vinyl toluene; and alkyl vinyl ethers.

### Embodiment 6

The foam adhesive article of any one of the previous embodiments, wherein the closed cell foam layer is a pressure sensitive adhesive.

### Embodiment 7

The foam adhesive article of any one of embodiments 1-5, wherein the closed cell foam layer is not a pressure sensitive adhesive.

### Embodiment 8

The foam adhesive article of any one of embodiments 1-5 or 7, further comprising a pressure sensitive adhesive layer comprising a pressure sensitive adhesive, wherein the pressure sensitive adhesive layer is disposed on a major surface of the closed cell foam layer.

### Embodiment 9

The foam adhesive article of embodiment 8, wherein the pressure sensitive adhesive layer comprises at least one an acrylic, a tackified acrylic, a tackified rubber-based adhesive, silicone, polyurethanes, and combinations thereof.

### Embodiment 10

The foam adhesive article of any one of embodiments 8-9, wherein the pressure sensitive adhesive is bonded to the extruded thermoplastic polymer foam layer.

### Embodiment 11

The foam adhesive article of any one of embodiments 8-10, wherein a primer layer is disposed between the closed cell foam layer and the pressure sensitive adhesive layer.

### Embodiment 12

The foam adhesive article of any one of embodiments 8-11, wherein the pressure sensitive adhesive is disposed on two opposing major surfaces of the closed cell foam layer.

### Embodiment 13

The foam adhesive article of any one of the previous embodiments, wherein the foam adhesive article has a VOC of less than 1000 ppm as measured by VOC Test Method I.

### Embodiment 14

The foam adhesive article of any one of embodiments 6-13, further comprising a release liner, wherein release liner contacts at least one major surface of the pressure sensitive adhesive.

### Embodiment 15

An expandable foam precursor composition comprising: a thermoplastic polymer matrix and particles distributed therein, wherein the particles comprise:
(a) a plurality of thermoplastic expandable polymeric particles; and
(b) a plurality of sorbent particles, wherein the sorbent particle has a high specific surface area.

### Embodiment 16

The expandable foam precursor composition of embodiment 15, wherein the sorbent particle comprises at least one of an activated carbon, silica gel, a zeolite, and mixtures thereof.

### Embodiment 17

The expandable foam precursor composition of any one of embodiments 15-16, wherein the plurality of thermoplastic expandable polymeric particles comprise a thermoplastic polymeric shell and a core, wherein the core comprises at least one of a liquid, a gas, and combinations thereof.

### Embodiment 18

The expandable foam precursor composition of any one of embodiments 15-17, further comprising a plurality of hollow, non-polymeric particles.

### Embodiment 19

The expandable foam precursor composition of embodiment 18, wherein the plurality of hollow, non-polymeric particles have a crush strength of at least 2000 psi.

### Embodiment 20

The expandable foam precursor composition of any one of embodiments 15-19, wherein the thermoplastic polymer foam comprises an acrylic polymer formed by polymerization of(a) one or more monomeric (meth) acrylic esters of non-tertiary alkyl alcohols, wherein the alkyl alcohols have 1-20 carbon atoms and (b) one or more monomers selected from acrylic acid; acrylamide; methacrylamide; N,N-dimethyl acrylamide; itaconic acid; methacrylic acid; acrylonitrile; methacrylonitrile; vinyl acetate; N-vinyl pyrrolidone; isobornyl acrylate; cyano ethyl acrylate; N-vinylcaprolactam, maleic anhydride; hydroxyalkylacrylates; N,N-dimethyl aminoethyl (meth)acrylate; N,N-diethylacrylamide; beta-carboxyethyl acrylate; vinyl esters of neodecanoic, neononanoic, neopentanoic, 2-ethylhexanoic, or propionic acids; vinylidene chloride; styrene; vinyl toluene; and alkyl vinyl ethers.

### Embodiment 21

A method of making a foam adhesive article comprising: extruding a composition to form a closed cell foam layer the composition comprising (i) a thermoplastic polymer (ii) a plurality of hollow particles, wherein the hollow particles comprise at least one of thermoplastic expandable polymeric particles, non-polymeric particles, and mixtures thereof; and (iii) plurality of sorbent particles, wherein the sorbent particle has a high specific surface area.

### Embodiment 22

The method of embodiment 21, wherein the pressure sensitive adhesive is extruded onto the closed cell foam layer.

### Embodiment 23

The method of any one of embodiments 21-22, wherein the sorbent particle comprises at least one of an activated carbon, silica gel, a zeolite, and combinations thereof.

### Embodiment 24

The method of any one of embodiments 21-23, wherein the plurality of non-polymeric particles have a crush strength of at least 2000 psi.

### Embodiment 25

The method of any one of embodiments 21-24, wherein the plurality of thermoplastic expandable polymeric particles comprise a thermoplastic polymeric shell and a core, wherein the core comprises at least one of a liquid, a gas, and combinations thereof.

### Embodiment 26

The method of any one of embodiments 21-25, further comprising applying a pressure sensitive adhesive on at least one major surface of the closed cell foam layer.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

Materials

| Designation | Description |
|---|---|
| 6035 Transfer Tape | An adhesive transfer tape having low fogging |
| | characteristics and good adhesion to low surface |
| | energy substrates, and having a 127 |
| | micrometers thick, acrylic adhesive layer on a |
| | 107 micrometers thick, 58 pound, polycoated |
| | Kraft paper liner, available under the trade |
| | designation 3M LOW FOGGING ADHESIVE |
| | TRANSFER TAPES from 3M Company, St. |
| | Paul, MN. |
| Expandable | Heat-expandable polymeric microspheres |
| Microspheres | consisting of an acrylonitrile copolymer shell |
| | encapsulating a high boiling |
| | point liquid, isopentane, and having an average |
| | particle size (pre-expansion) of 20 to 30 |
| | micrometers, available under the trade |
| | designation DUALITE U010-185D from |
| | Henkel, North America, Greenville, SC. |
| Activated Carbon | Activated carbon available under the trade |
| | designation KURARYCOAL PGW-20MP |
| | having an average pore diameter of 20 |
| | micrometers, available from Kuraray Chemical |
| | Company, Osaka, Japan. |
| Carbon Black | Carbon black, available under the trade |
| | designation REGAL 660 from Cabot |
| | Corporation, Billerica, MA. |
| IRGACURE 651 | 2,2-dimethoxy-1,2-diphenylethan-1-one, a |
| | photoinitiator, available under the trade |
| | designation IRGACURE 651 from BASF |
| | Corporation, Florham Park, NJ. |
| EVA Film | A heat sealable 0.0635 millimeter (0.0025 inch) |
| | thick ethylene-vinyl acetate film having 6% |
| | vinyl acetate, available under the trade |
| | designation VA24 from Consolidated |
| | Thermoplastics Company, Schaumburg, IL. |
| IOTG | isooctyl thioglycolate |
| EHA | 2-ethyl hexyl acrylate, available from BASF |
| | Corporation, Florham Park, NJ. |
| AA | Acrylic acid, available from BASF Corporation, |
| | Florham Park, NJ. |

Test Methods

1) VOC Test Method I

Analysis of volatile organic emissions (VOC) and FOG properties was done according to the German Automotive Industry Association (Verband der Automobilindustrie (VDA)) test method VDA 278 (2011): “Thermal Desorption Analysis of Organic Emissions for the Characterization of Non-Metallic Materials for Automobiles” using Markes Unity Thermal Desorption (Markes International, Limited, Llantrisant, Wales, UK)/Agilent 6890/5973 GC/MS (Agilent Technologies, Incorporated, Santa Clara, Calif.) instrumentation with the following modification. The samples were not evaluated seven days after the initial test. Toluene and hexadecane were used as surrogate standards for VOC and FOG measurements respectively. The sample mass of the foam was calculated after subtracting out the mass of the liners and backing used. Two samples were run and the higher value was reported.

A. Foam Only

Within 48 hours of preparation, the roll of the foamed article stored in a plastic bag was removed from the bag, samples cut therefrom, and a second release liner applied to the exposed foam surface and rubbed down by hand with a plastic squeegee. Some of the resulting laminate articles were treated with electron beam irradiation and others were not. In both cases, the laminate articles were wrapped in aluminum foil, taped shut, and stored for 44 days at room temperature. Next, the laminate articles were removed from the foil and test specimens measuring approximately 2 millimeters wide and between 2 and 3 centimeters long were cut, weighed, one release liner removed, the exposed foam surface applied to a preweighed piece of unprimed polyester film backing, and the second release liner removed. The resulting unprimed polyester film/foam construction was then folded into a “V” shape along its' length and positioned inside the mid-section of a 6.35 millimeter (0.25 inch) diameter glass tube and placed in the thermal desorption system. The combined weight of the two release liners was used to calculate the mass of the foam sample itself. Testing was also done on both the unprimed polyester film alone as well as an empty glass tube. This information was used in the data analysis to obtain test results for the mass of the foam alone, both with and without electron beam treatment. The results are reported as microgram (μg) VOC per gram (g) of the foam.

B. Foam with Pressure Sensitive Adhesive Skin Layers

A roll of the foamed article stored in a plastic bag was removed from the bag and samples cut therefrom. Some samples were immediately covered on their exposed surface with a second release liner as described in “IA. Foam Only” above. To some samples, one or both sides of the foam layer were provided with a skin layer of a pressure sensitive adhesive as described in “Lamination of Pressure Sensitive Adhesive Skin Layer(s)” below. All of these samples had release liner covering the foam and adhesive surfaces and were wrapped in aluminum foil, taped shut, stored for 15 days, then tested as described in “IA. Foam Only” above. The results are reported as microgram (μg) VOC per gram (g) of the foam and adhesive layer(s), if present.

2) VOC Test Method II

Foam samples were prepared by removing the roll of the foamed article from the plastic bag it was stored in, cutting samples therefrom, applying a second release liner to the exposed foam surface, and rubbing it down by hand using a plastic squeegee. Some of the resulting laminate articles were treated with electron beam irradiation and others were not. In both cases the laminate articles were wrapped in aluminum foil, taped shut, and stored for 11 days at room temperature as described in “IA. Foam Only” above. Next, the laminate articles were removed, and test specimens and standards were prepared and analyzed generally according to JASO M902:2011: Diffused Volatile Organic Compounds (VOC).

Samples measuring 100 square centimeters were cut and weighed. After removing both release liners, each sample was placed between aluminum foil and a lint-free paper tissue. The samples were then placed in 10 liter poly(vinylidene fluoride) gas sampling bags (available from SKC Incorporated, Eighty-Four, Pa.) which were then filled with nitrogen, heat-sealed shut, and placed in an oven maintained at a constant temperature of 80° C. for two hours, after which the contents were then evaluated. The combined weight of the two release liners was used to calculate the mass of the foam sample itself. This information was used in the data analysis to obtain test results for the mass of the foam alone, both with and without electron beam treatment. The collected gas volume for VOC measurements was 1 liter, and for carbonyl measurements was 2 liters.

Analysis of volatile organic emissions (VOC) was done generally according to the Japanese Automobile Standard JASO M902:2011: “Automotive Parts—Interior Parts and Materials—Measurement Methods of Diffused Volatile Organic Compounds (VOC)” using Markes Unity Thermal Desorption (Markes International, Limited, Llantrisant, Wales, UK)/Agilent 6890/5973 GC/MS (Agilent Technologies, Incorporated, Santa Clara, Calif.) instrumentation and helium as the carrier gas. The amounts of individual VOC components were calculated using comparative samples of the same VOCs having known concentrations. The total VOC values were calculated using a surrogate standard of hexadecane, and was taken as the sum of the materials eluted between hexane and hexadecane.

Analysis of derivatized carbonyl compounds (e.g., acetaldehyde) was done using Agilent 1200 LC (Agilent Technologies, Incorporated, Santa Clara, Calif.)/G1946 Quadrapole MS instrumentation having a C18 reverse phase column. Compounds were eluted using a mixture of aqueous ammonium formate and a gradient of acetonitrile. The carbonyl derivatives were detected by monitoring the masses of their ammonium adducts in the mass selective detector. Quantitation was done relative to purchased standards of the derivatives and the results calculated as free aldehyde. The results are reported as milligrams (mg) of the VOC per square meter (m²) of sample.

Hot Melt Composition for Use as Foam

Two sheets of EVA Film were heat sealed on the lateral edges and the bottom to form a rectangular package on a liquid form, fill, and seal machine as described in U.S. Pat. No. 5,804,610. This was filled with a pressure sensitive adhesive foam precursor composition having 90 parts 2EHA, 10 parts AA, 0.15 parts of IRGACURE 651, and 0.04 phr of IOTG. The filled package was then heat sealed at the top in the cross direction to form a package measuring approximately 14.0 centimeters long by 5.0 centimeters wide by 0.5 centimeter thick containing approximately 25 grams of composition. The packages were then placed in a water bath that was maintained at between about 16° C. and 32° C. (61° F. and 90° F.) and exposed to ultraviolet radiation from a UV-A light source, having 90% of its' emissions between 300 and 400 nanometers and a peak emission between 350 and 400 nanometers, for 21 minutes to provide a calculated total UV-A energy of approximately 2150 milliJoules per square centimeter.

Foam Preparation

The UV-irradiated packages were fed into a twin screw extruder using a Bonnot single screw extruder with the barrel and hose temperatures set at about 93° C. If used, the Activated Carbon, Carbon Black, and Expandable Microspheres were supplied to the twin screw extruder using powder feeders. The twin screw extruder had a diameter of 25 millimeters and a length:diameter ratio of 46, was operated at 200 revolutions per minute (rpm), and was equipped with nine zones which used the temperature setpoints shown in Table 1 below. Also shown in this table are the feed rates and points of addition. The extruded material was deposited onto a polyester film release liner having a silicone coating on both sides. As the melt mixture exited the die, the expandable microspheres in the melt mixture expanded to provide a foamed article having an approximate thickness of 1.0 millimeter (0.040 inches). This was rolled up and stored in a plastic bag until further use.

TABLE 1
Extruder Conditions

| | Temperature | |
|---|---|---|
| Zone | Setpoint (° C.) | Input Material and Rate of Addition |
| 1 | 125 | Hot Melt Composition at 4.54 kilograms/ |
| | | hr. (10 pounds/hr.) |
| 2 | 125 | |
| 3 | 125 | Vacuum applied in some instances (see |
| | | examples) |
| 4 | 125 | Activated Carbon or Carbon Black at |
| | | various feed rates (see examples) |
| 5 | 125 | |
| 6 | 125 | |
| 7 | 125 | Expandable Microspheres at 0.14 |
| | | kilograms/hr. (0.31 pounds/hr.) |
| 8 | 153 | |
| 9 | 153 | |
| Gear Pump | 125 | |
| Hose | 193 | |
| Output Die | 193 | |

Lamination of Pressure Sensitive Adhesive Skin Layer(s)

In some instances the foam was provided with an adhesive skin layer on one or both sides as follows. The exposed adhesive surface of 6035 Transfer Tape was brought into contact with the surface of the foam and pressed into intimate contact with it using a 2 kilogram (4.4 pounds) rubber roller and hand pressure.

Electron Beam Irradiation

Some foams were exposed to electron beam irradiation sequentially on each side using an electron beam generating apparatus (Model CB 300, available from Energy Sciences, Incorporated, Wilmington, Mass.) in an inerted chamber of the apparatus, an accelerating voltage of 220 KiloVolts, and a dose of either 6 or 12 MegaRads.

### EXAMPLES

Shown in Table 2 are the VOC levels of various foams were tested by VOC Test Method I (Method A). For each example, whether or not a vacuum was applied during extrusion, and the amounts of activated carbon or carbon black, if used, are reported. Also shown in Table 2 is the VOC level on the foam articles with no Ebeam exposure and with 6 MRad or 12 MRad Ebeam exposure.

TABLE 2

| | Foam | | | | | |
|---|---|---|---|---|---|---|
| | Vacuum | | | | | |
| | applied in | | | | | |
| | Extruder | | | VOC (micrograms/gram) | | |
| | (inches | Activated | Carbon | Ebeam | Ebeam | Ebeam |
| Ex. | Hg) | Carbon | Black | dose | dose | dose |
| No. | (KPa Hg) | (wt %) | (wt %) | None | 6 MRads | 12 MRads |
| 1 | none | 8 | none | 79 | NT | NT |
| 2 | none | 10 | none | 54 | 84 | 113 |
| 3 | 20 | 10 | none | 50 | 116 | NT |
| | (67.7) | | | | | |
| CE 1 | none | none | none | 3597 | 3397 | 3034 |
| CE 2 | none | none | 10 | 3016 | 3036 | 4770 |
| CE 3 | 20 | none | none | 1472 | NT | NT |
| | (67.7) | | | | | |

Note:
All Examples and Comparative Examples contained 3 wt % of expandable microspheres.
NT means not tested.

Shown in Table 3 are the VOC and FOG levels of various examples tested by VOC Test Method I (Method B). For each example, if used, the amounts of activated carbon or carbon black are reported along with the PSA skin layers.

TABLE 3

| | Activated | Carbon | | | | | |
|---|---|---|---|---|---|---|---|
| | Carbon | Black in | PSA | PSA | | | |
| Ex. | in Foam | Foam | Skin | Skin | | VOC | FOG |
| No. | (wt %) | (wt %) | Layer 1 | Layer 2 | Construction | (μg/g) | (μg/g) |
| 1 | 8 | none | none | none | —/Foam/— | 79 | 10 |
| 4 | 8 | none | yes | none | PSA/Foam/— | 585 | 352 |
| 5 | 8 | none | yes | yes | PSA/Foam/PSA | 713 | 200 |
| CE 2 | none | 10 | none | none | —/Foam/— | 3016 | 374 |
| CE 3 | none | none | none | none | —/Foam/— | 1472 | 144 |
| CE 4 | none | 10 | yes | none | PSA/Foam/— | 2091 | 245 |
| CE 5 | none | 10 | yes | yes | PSA/Foam/PSA | 2570 | 443 |
| CE 6 | none | none | yes | none | PSA/Foam/— | 3423 | 691 |
| CE 7 | none | none | yes | yes | PSA/Foam/PSA | 3812 | 653 |
| CE 8 | none | none | yes | none | PSA Layer only | 16460 | 2920 |

Note:
The Examples and Comparative Examples in Table 3 all contained 3 wt % of expandable microspheres, except CE 8, and none were treated with electron beam irradiation.
Note:
Comparative Example 8 is a layer of PSA only, no foam layer.
Note:
The results for Example 1 and Comparative Examples 2 and 3 are from Table 2: VDA - Method A.

Shown in Table 4 are the VOC levels of various examples tested by VOC Test Method II. CE 9-CE 11 did not comprise any activated carbon and were exposed to different levels of Ebeam radiation as shown in Table 4. Ex. 6 comprised 8% by weight of activated carbon and was Ebeam treated at 6 MRads. The total VOC is reported in Table 4 along with the amount of various individual volatile compounds.

TABLE 4

| | | Example No. | | | |
|---|---|---|---|---|---|
| | | 6 | CE 9 | CE 10 | CE 11 |
| Ebeam (MRads) | | 6 | None | 6 | 12 |
| VOC | Xylenes | <5 | 12 | 12 | 11 |
| (mg/m²) | Ethylbenzene | <5 | <1 | 6 | 8 |
| | Styrene | <5 | <5 | <5 | <5 |
| | Tetradecane | <5 | 24 | 35 | 41 |
| | Benzene | <5 | <5 | <5 | <5 |
| | Acrolein | <15 | <15 | <15 | <15 |
| | Toluene | <5 | 837 | 726 | 584 |
| | Acetaldehyde | 194 | 515 | 187 | 90 |

| | | | | |
|---|---|---|---|---|
| Total VOC (mg/m²) | <5E+03 | 9.00E+04 | 1.00E+05 | 1.00E+05 |

Note:
Example and all Comparative Examples contained 3 wt % of expandable microspheres.

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will control.

1. A foam adhesive article comprising:
a closed cell foam layer comprising an extruded thermoplastic polymer foam and particles distributed therein, wherein the particles comprise:
(a) a plurality of hollow particles, wherein the hollow particles comprise at least one of (i) thermoplastic expanded polymeric particles, (ii) non-polymeric particles, and (iii) mixtures thereof; and
(b) a plurality of sorbent particles, wherein the sorbent particle comprises activated carbon and has a high specific surface area.

2. (canceled)

3. The foam adhesive article of claim 1, wherein the plurality of non-polymeric particles have a crush strength of at least 2000 psi.

4. The foam adhesive article of claim 1, wherein the plurality of thermoplastic expanded polymeric particles comprise a thermoplastic polymeric shell and a core, wherein the core comprises at least one of a liquid, a gas, and combinations thereof.

5. The foam adhesive article of claim 1, wherein the extruded thermoplastic polymer foam comprises an acrylic polymer formed by polymerization of (a) one or more monomeric (meth) acrylic esters of non-tertiary alkyl alcohols, wherein the alkyl alcohols have 1-20 carbon atoms and (b) one or more monomers selected from acrylic acid; acrylamide; methacrylamide; N,N-dimethyl acrylamide; itaconic acid; methacrylic acid; acrylonitrile; methacrylonitrile; vinyl acetate; N-vinyl pyrrolidone; isobornyl acrylate; cyano ethyl acrylate; N-vinylcaprolactam, maleic anhydride; hydroxyalkylacrylates; N,N-dimethyl aminoethyl (meth)acrylate; N,N-diethylacrylamide; beta-carboxyethyl acrylate; vinyl esters of neodecanoic, neononanoic, neopentanoic, 2-ethylhexanoic, or propionic acids; vinylidene chloride; styrene; vinyl toluene; and alkyl vinyl ethers.

6. The foam adhesive article of claim 1, wherein the closed cell foam layer is a pressure sensitive adhesive.

7. The foam adhesive article of claim 1, wherein the closed cell foam layer is not a pressure sensitive adhesive.

8. The foam adhesive article of claim 1, further comprising a pressure sensitive adhesive layer comprising a pressure sensitive adhesive, wherein the pressure sensitive adhesive layer is disposed on a major surface of the closed cell foam layer.

9. The foam adhesive article of claim 8, wherein the pressure sensitive adhesive layer comprises at least one an acrylic, a tackified acrylic, a tackified rubber-based adhesive, silicone, polyurethanes, and combinations thereof.

10. The foam adhesive article of claim 8, wherein the pressure sensitive adhesive is bonded to the extruded thermoplastic polymer foam layer.

11. The foam adhesive article of claim 8, wherein a primer layer is disposed between the closed cell foam layer and the pressure sensitive adhesive layer.

12. The foam adhesive article of claim 8, wherein the pressure sensitive adhesive is disposed on two opposing major surfaces of the closed cell foam layer.

13. An expandable foam precursor composition comprising: a thermoplastic polymer matrix and particles distributed therein, wherein the particles comprise:
(a) a plurality of thermoplastic expandable polymeric particles; and
(b) a plurality of sorbent particles, wherein the sorbent particle comprises activated carbon and has a high specific surface area.

14. A method of making a foam adhesive article comprising: extruding a composition to form a closed cell foam layer the composition comprising (i) a thermoplastic polymer (ii) a plurality of hollow particles, wherein the hollow particles comprise at least one of thermoplastic expandable polymeric particles, non-polymeric particles, and mixtures thereof; and (iii) plurality of sorbent particles, wherein the sorbent particle comprises activated carbon and has a high specific surface area.

15. The foam adhesive article of claim 1, wherein the foam adhesive article has a VOC of less than 1000 ppm as measured by VOC Test Method I.

16. The foam adhesive article of claim 6, further comprising a release liner, wherein release liner contacts at least one major surface of the pressure sensitive adhesive.

17. The method of claim 14, wherein the pressure sensitive adhesive is extruded onto the closed cell foam layer.

18. The method of claim 14, further comprising applying a pressure sensitive adhesive on at least one major surface of the closed cell foam layer.
